(19) United States
(12) Patent Application Publication
(10) Pub. No.: US 2021/0154853 A1
(43) Pub. Date: May 27, 2021

(54) ROBOT MOTION CONTROL METHOD AND APPARATUS AND ROBOT USING THE SAME

(71) Applicant: UBTECH ROBOTICS CORP LTD, Shenzhen (CN)

(72) Inventors: HONGGE WANG, Shenzhen (CN); Ligang Ge, Shenzhen (CN); Yizhang Liu, Shenzhen (CN); Jie Bai, Shenzhen (CN); Youjun Xiong, Shenzhen (CN); Jianxin Pang, Shenzhen (CN)

(21) Appl. No.: 16/734,400

(22) Filed: Jan. 5, 2020

(30) Foreign Application Priority Data
Nov. 25, 2019 (CN) 201911168350.8

(51) Int. Cl. B25J 9/16; B25J 9/00

(52) U.S. Cl. CPC B25J 9/1697; B25J 9/1666; B25J 9/0006

(57) ABSTRACT

The present disclosure provides a robot motion control method as well as an apparatus and a robot using the same. The method includes: obtaining geometric parameter(s) of a target step, where the geometric parameters comprise a step width and a step height of the target step; determining at least two time-displacement coordinates and a velocity vector corresponding to each time-displacement coordinate based on the geometric parameters; generating a motion trajectory by fitting the at least two time-displacement coordinates and the corresponding velocity vectors; and controlling feet of the robot to move based on the motion trajectory. In this manner, the feet of the robot can be prevented from colliding violently with the step during going up the step so as to improve the safety and stability.

### CROSS REFERENCE TO RELATED APPLICATIONS

The present disclosure claims priority to Chinese Patent Application No. 201911168350.8, filed Nov. 25, 2019, which is hereby incorporated by reference herein as if set forth in its entirety.

### BACKGROUND

### 1. Technical Field

The present disclosure relates to robot technology, and particularly to a robot motion control method as well as an apparatus and a robot using the same.

### 2. Description of Related Art

Compared with wheeled and tracked robots, a big advantage of biped robots is that they can fully adapt to the living environment of humans so as to, for example, walk on uneven ground and going up and down stairs.

Since the biped robots may work in a variety of environments, the feet of the biped robots easily collide with the steps during going up the steps, and even cause serious damage to the biped robots.

Therefore, it is necessary to provide a new method to solve the above-mentioned technical problems.

### BRIEF DESCRIPTION OF THE DRAWINGS

In order to more clearly illustrate the technical solutions in the embodiments of the present disclosure, the drawings used in the embodiments or the description of the prior art will be briefly introduced below. It should be understood that, the drawings in the following description are only examples of the present disclosure. For those skilled in the art, other drawings can be obtained based on these drawings without creative works.

FIG. 1 is a flow chart of a robot motion control method according to an embodiment of the present disclosure.

FIG. 2 is a schematic diagram of an example of a rectangular coordinate system of a robot according to an embodiment of the present disclosure.

FIG. 3 is a schematic diagram of an example of a motion trajectory of a robot according to an embodiment of the present disclosure.

FIG. 4 is a schematic block diagram of a robot motion control apparatus according to an embodiment of the present disclosure.

FIG. 5 is a schematic block diagram of a robot according to an embodiment of the present disclosure.

### DETAILED DESCRIPTION

in the following descriptions, for purposes of explanation instead of limitation, specific details such as particular system architecture and technique are set forth in order to provide a thorough understanding of embodiments of the present disclosure. However, it will be apparent to those skilled in the art that the present disclosure may be implemented in other embodiments that are less specific of these details. In other instances, detailed descriptions of well-known systems, devices, circuits, and methods are omitted so as not to obscure the description of the present disclosure with unnecessary detail.

It is to be understood that, when used in the description and the appended claims of the present disclosure, the terms “including” and “comprising” indicate the presence of stated features, integers, steps, operations, elements and/or components, but do not preclude the presence or addition of one or a plurality of other features, integers, steps, operations, elements, components and/or combinations thereof.

It is also to be understood that the term “and/or” used in the description and the appended claims of the present disclosure refers to any combination of one or more of the associated listed items and all possible combinations, and includes such combinations.

As used in the description and the appended claims, the term “if” may be interpreted as “when” or “once” or “in response to determining” or “in response to detecting” according to the context. Similarly, the phrase “if determined” or “if [the described condition or event] is detected” may be interpreted as “once determining” or “in response to determining” or “on detection of [the described condition or event]” or “in response to detecting [the described condition or event]”.

In addition, in the descriptions of the specification and the claims of the present disclosure, the terms “first”, “second”, “third”, and the like are only used for distinguishing, and cannot be understood as indicating or implying relative importance.

“One embodiment” or “some embodiments” and the like described in the specification of the present disclosure mean that a particular feature, structure, or characteristic which combines the description of the embodiment is included in one or more embodiments of the present disclosure. Thus, the sentences “in one embodiment”, “in some embodiments”, “in other embodiments”, “in the other embodiments” and the like that appear in different places of this specification are not necessarily to refer to the same embodiment, but rather mean “one or more but not all embodiments” unless otherwise specifically emphasized. The terms “including”, “comprising”, “having” and their variations all mean “including but not limited to” unless otherwise specifically emphasized.

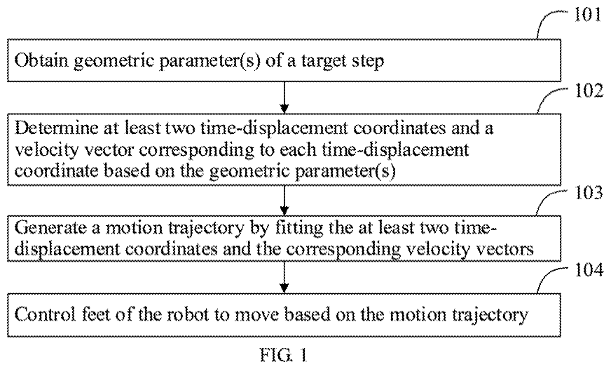

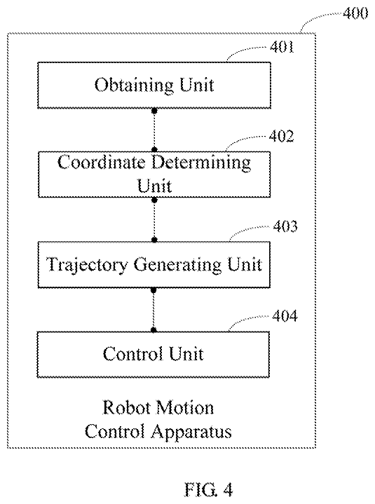

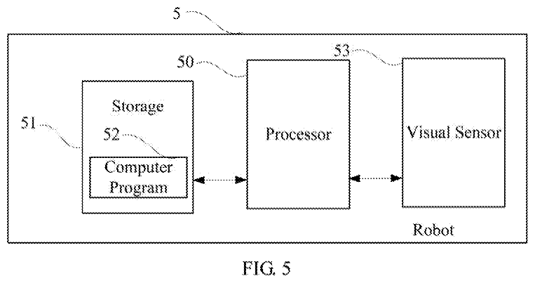

FIG. 1 is a flow chart of a robot motion control method according to an embodiment of the present disclosure. In this embodiment, a motion control method for a robot is provided, where the robot is a biped robot which has two feet. The method is a computer-implemented method executable for a processor, which may be implemented through and applied to a motion control apparatus as shown in FIG. 4 or a robot as shown in FIG. 5, or implemented through a computer readable storage medium. As shown in FIG. 1, the method includes the following steps.

101: obtaining geometric parameter(s) of a target step.

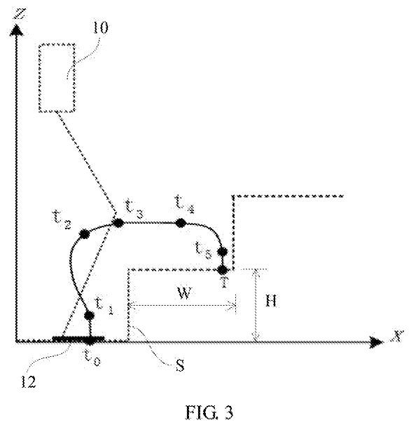

In this embodiment, it can obtain the geometric parameters of the target step of a staircase through a visual sensor disposed on the robot, for instance, it can obtain image information of the target step through a camera, and then calculate the geometric parameters of the target step based on the image information of the target step; or it can input the geometric parameters by the user, which is not limited herein. In which, the target step is one level of step for the robot to climb. In the process of the robot going up the step, what has the greatest impact on the movement of the robot is the trajectory planning of the feet of the robot in a vertical direction and a forward direction (i.e., the direction of the movement of the robot). Therefore, the geometric parameters of the target step need to include at least a step width W (see FIG. 3) and a step height H (see FIG. 3) of the target step.

In one embodiment, the above-mentioned step 101 includes:

A1: detecting in real time whether there is a step in a forward direction of the robot; and

A2: using the step as the target step if there is the step in the forward direction of the robot, and measuring the geometric parameter(s) of the target step.

In which, during the movement of the robot, it is detected in real time that whether there is a step in the forward direction of the robot. If a step is detected, the one level of step that is closest to the support foot of the robot is used as the target step, and then the geometric parameters of the target step are measured. For example, when the robot walks on a flat ground, if it detects that there is a staircase in the forward direction, and the staircase contains a plurality of steps, the robot will take the first step closest to the support foot of the robot as the target step, and then execute the motion control method to climb the first step, and then execute the above-mentioned step A1 again to update the target step. If the above-mentioned robot does not detect a step in the forward direction, it will not execute the motion control method.

In one embodiment, the above-mentioned step A1 includes:

B1: obtaining a shape feature of an object in the forward direction of the robot;

B2: comparing the shape feature with a preset step shape diagram;

B3: determining there being a step in front of the robot, if the shape feature matches the step shape diagram; and

B4: determining there being no step in front of the robot, if the shape feature not matches the step shape diagram.

In which, the above-mentioned robot obtains the shape feature of the object in the forward direction of the robot in real time through a shape detection device (e.g., a visual sensor) disposed on the robot, and then compares the above-mentioned shape feature with step shape diagrams stored in a storage of the robot in advance. The number of the step shape diagrams is at least one, where the step shape diagram can indicate the shape of steps. The step shape diagram can be obtained from a network such as the Internet, or be accumulated from the development project of the robot, which is not limited herein. In the case that them is at least one step shape diagram matching the shape feature, it is determined that there is a step in front of the robot; otherwise, in the case that there is no step shape diagram matching the shape feature map, it is determined that there is no step in front of the robot. Furthermore, the shape feature can also be identified through a trained neural network, where the neural network is trained through a large number of step shape diagrams to identify whether the shape feature of the object in the forward direction of the robot is a shape feature of steps.

102: determining at least two time-displacement coordinates and a velocity vector corresponding to each time-displacement coordinate based on the geometric parameter(s).

In this embodiment, the at least two time-displacement coordinates are determined based on the step height and step width of the above-mentioned target step. The “time” in the time-displacement coordinate indicates the moments during the robot going up the step, and the “displacement” in the time-displacement coordinate indicates the displacement of the feet of the robot with respect to the starting position of going up the step. Each time-displacement coordinate corresponds to one velocity vector, and the velocity vector indicates the velocity and direction of the feet of the robot when it moves with the corresponding displacement.

In one embodiment, the above-mentioned step 102 includes:

C1: creating a first rectangular coordinate system by taking time as a horizontal axis and a displacement in a forward direction of the robot as a vertical axis;

C2: determining five forward key points on the first rectangular coordinate system and forward velocity vectors each corresponding to the five forward key points, respectively, based on preset forward constraint conditions, where the coordinate of the five forward key points are respectively P₁ (0, x₀), P: (t1, x₁), P₃ (t₂, x₂), P₄ (t₅, x₅), and P₅ (T, x_{T}), the forward velocity vectors corresponding to the five forward key points P₁, P₂, P₃, P₄ and P₅ are vₓ₀, vₓ₁, vₓ₂, vₓ₅, and v_{xT}, respectively, and the forward constraint conditions are x₀=x₁=x₂=0, and x₅=x_{T}=xₘ, where xₘ is the maximum forward displacement determined based on the step width, vₓ₀=vₓ₁=vₓ₅=v_{xT}=0, and vₓ₂ is larger than 0;

C3: creating a second rectangular coordinate system by taking time as a horizontal axis and the displacement of the robot in a vertical direction as a vertical axis; and

C4: determining five vertical key points on the second rectangular coordinate system and vertical velocity vectors each corresponding to the five vertical key points respectively based on preset vertical constraint conditions, where the coordinate of the five vertical key points are respectively Q₁ (0, z₀), Q₂ (t₂, z₂), Q₃ (t₃, z₃), Q₄ (t₄, z₄), and Q₅ (T, z_{T}), and the vertical velocity vectors corresponding to the five vertical key points Q₁, Q₂, Q₃, Q₄, and Q₅ are v_{z0}, v_{z2}, v_{z3}, v_{z4}, and v_{zT}, respectively, the vertical constraint conditions are z₀=0, z₃=z₄>z₂>z_{T}=h, h is the step height, v_{z0}=v_{z3}=v_{z4}=v_{zT}=0, v_{z2}>0, and T>t₅>t₄>t₃>t₂>t₁>0.

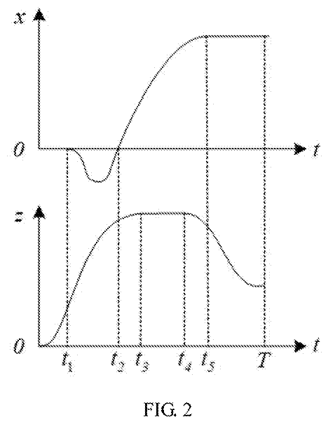

FIG. 2 is a schematic diagram of an example of a rectangular coordinate system of a robot according to an embodiment of the present disclosure. As shown in FIG. 2, the coordinate system in FIG. 2 that with the x-axis as the vertical axis is the first rectangular coordinate system, where the t-axis in FIG. 2 shows the moments during the robot going up the step, and the x-axis in FIG. 2 shows the displacement component in the forward direction of the robot of the feet of the robot with respect to the starting position of going up the step. The origin 0 on the x-axis in FIG. 2 shows the time and displacement of the feet of the robot at the starting position during going up the step, where the displacement in the forward direction of the robot is the positive direction of the x-axis. Based on the preset forward constraint conditions, the five forward key points and the forward velocity vectors corresponding to the five forward key points, respectively, are determined on the first rectangular coordinate system. The coordinates of the five forward key points are respectively P₁ (0, x₀), P₂ (t₁, x₁), P₃ (t₂, x₂), P₄ (t₅, X₅), and P₅ (T, x_{T}), and the forward velocity vectors corresponding to the above-mentioned five forward key points P₁, P₂, P₃, P₄, and P₅ are vₓ₀, vₓ₁, vₓ₂, vₓ₅, and v_{xT}, respectively. The above-mentioned forward constraint conditions are x₀=x₁=x₂=0, and x₅=x_{T}=xₘ, where xₘ is the maximum forward displacement determined based on the above-mentioned step width, vₓ₀=vₓ₁=vₓ₅=v_{xT}=0, and vₓ₂ is larger than 0; where, since x₁=x₂=0, vₓ₁=0, and vₓ₂ is larger than 0, before time t₂ and after time t₁, a curve of first fall and then rise can be formed, which react to the movement of the feet of the robot to cause the foot swings backwards with respect to the forward direction first and then kicks forwards, so that the feet of the robot have a forward swing velocity when returning to the position of zero displacement, thereby reducing the maximum acceleration of the feet in the forward direction during going up the step. In this embodiment, it can set vₓ₂=xₘ/(t₅−t₂), that is, the average forward velocity of the feet in the forward direction.

Similarly, the coordinate system in FIG. 2 that with the z-axis as the vertical axis is the second rectangular coordinate system. The t-axis in FIG. 2 shows the moments during the robot going up the step, and the z-axis in FIG. 2 shows the displacement component of the displacement of the feet of the robot with respect to the starting position of going up the step in the vertical direction of the robot. The origin 0 on the z-axis in FIG. 2 shows the time and displacement of the feet of the robot at the starting position during going up the step. In which, the displacement in an upward direction which is vertical to the horizontal plane of stair, of the robot is taken as the positive direction of the z-axis. The five vertical key points and the vertical velocity vectors corresponding to the five vertical key points, respectively, are determined on the second rectangular coordinate system based on the preset vertical constraint conditions. The coordinates of the above-mentioned five vertical key points are respectively Q₁ (0, z₀), Q₂ (t₂, z₂), Q₃ (t₃, z₃), Q₄ (t₄, z₄), and Q₅ (T, z_{T}). The vertical velocity vectors corresponding to the five vertical key points Q1, Q2, Q3, Q4, and Q5 are v_{z0}, v_{z2}, v_{z3}, v_{z4}, and v_{zT}, respectively. The above-mentioned vertical constraints are z₀=0, z₃=z₄>z₂>z_{T}=h, where H is the above-mentioned step height, v_{z0}=v_{z3}=v_{z4}=v_{zT}=0, v_{z2}>0, T>t₅>t₄>t₃>t₂>t₁>0. For example, z₂=h+0.01, which can ensure that the feet of the robot have above the step height of the step before swinging to a vertical surface of the target step; z₃=z₄=z₂+0.03, which can ensure that the feet of the robot to move along the forward direction at a certain height. Preferably, it can assume v_{z2}=z₃/t₃, that is, the average rising velocity in the vertical direction during the feet of the robot going on the step.

103: generating a motion trajectory by fitting the at least two time-displacement coordinates and the corresponding velocity vectors.

In this embodiment, based on the above-mentioned at least two determined time-displacement coordinates and the corresponding velocity vectors, a time-forward displacement curve in the forward direction of the feet of the robot and a time-vertical displacement curve in the vertical direction of the feet of the robot can be generated. By mapping the above-mentioned time-forward direction curve and the time-vertical displacement curve into a same space coordinate, it can generate the motion trajectory of the feet of the robot to go up the step by fitting.

In one embodiment, the motion trajectory includes a foot lifting trajectory segment, a back swing trajectory segment, an advancing trajectory segment, and a foot falling trajectory segment; a starting point of the back swing trajectory segment is a turning-out point of the foot lifting trajectory segment, an end point of the back swing trajectory segment and a turning-in point of the advancing trajectory segment are connected by a smooth curve, and a turning-out point of the advancing trajectory segment and a turning-in point of the foot falling trajectory segment are connected by another smooth curve;

where, the foot lifting trajectory segment is perpendicular to the advancing trajectory segment, the foot lifting trajectory segment is parallel to the foot falling trajectory segment, the end point is located on a same straight line as the foot lifting trajectory segment, and an included angle between a tangent direction of the end point and a forward direction of the robot is an acute angle.

FIG. 3 is a schematic diagram of an example of a motion trajectory of a robot according to an embodiment of the present disclosure. As shown in FIG. 3, the foot lifting trajectory segment (t0˜t1) is a vertical line parallel to the vertical surface of the target step S, which is used to ensure that the feet 12 are raised vertically when the robot 10 is moved according to the foot lifting trajectory segment so as to avoid colliding with the step. The back swing trajectory segment (t1˜t2) is a curve with a certain arc, which is used to ensure that when the robot is moved according to the back swing trajectory segment, the feet first swing backward with respect to the forward direction and then kick forward; and when the feet kick forward to return to the position before swinging back, it makes the height of the foot higher than the step height of the target step. When the feet of the robot moves to the end point of the back swing trajectory segment, the foot has a forward velocity, and at the same time the velocity of the vertical rise of the foot starts to decrease until the vertical rise velocity of the foot is reduced to 0 and enters the advancing trajectory segment. The advancing trajectory segment is a horizontal line parallel to a horizontal step surface of the target step. When the feet of the robot moves to the advancing trajectory segment, it will move along the forward direction while keeps a certain distance from the horizontal step surface of the target step. When the feet of the robot moves to the turning-out point of the advancing trajectory segment, the feet has a vertical downward velocity, and at the same time the velocity of the feet in the forward direction starts to decrease until the velocity of the feet in the forward direction reduces to 0 and enters the foot falling trajectory segment. The foot falling trajectory segment is a vertical line parallel to the foot lifting trajectory segment. When the feet of the robot moves to the foot falling trajectory segment, the foot will fall vertically and the velocity will start to decrease. When the foot falls on the horizontal step surface of the target step, the velocity decreases to zero.

In one embodiment, the above-mentioned step 103 includes:

D1: generating the motion trajectory by fitting the at least two time-displacement coordinates and the corresponding velocity vectors through an interpolation algorithm.

In which, after the at least two time-displacement coordinates and the corresponding velocity vectors are determined, an interpolation can be performed between the time-displacement coordinates to obtain a smooth curve. The interpolation algorithm used for interpolation includes, but is not limited to, a cubic polynomial curve algorithm, a cubic spline curve algorithm, or a cubic Hermite curve algorithm.

In one embodiment, the above-mentioned step D1 includes:

using the at least two time-displacement coordinates and the corresponding velocity vectors as the constraint condition to calculate a coefficient of a cubic curve formula; and

generating the motion trajectory based on the coefficient.

in which, a cubic curve formula can be set first, and then the above-mentioned at least two time-displacement coordinates and the corresponding velocity vectors are used as the constraint conditions of the cubic curve formula. Based on the constraint conditions and the set cubic curve formula, the equations are solved simultaneously to obtain the coefficients of the above-mentioned cubic curve formula. Based on the coefficients, the motion trajectory of the feet of the robot can be generated. For example, by setting the two time-displacement coordinates as (t₀=0, x₀) and (t_{f}, x₁), where the velocity vector corresponding to the coordinate (t₀, x₀) is v₀, and the velocity vector corresponding to the coordinate (t_{f}, x₁) is v₁, and setting the cubic curve formula as x(t)=f(x_{Q},x₁,v₀,v₁,t_{f},t)=a₀+a₁t+a₂t²+a₃t³, where a₀, a₁, a₂, and a₃ are the coefficients, then it can calculate to obtain a₀=x₀, a₁=v₁,

$${a}_{2} = \frac{3}{{t}_{f}^{2}} ( {x}_{1} - {x}_{0} ) - \frac{2}{{t}_{f}} {v}_{0} - \frac{1}{{t}_{f}} {v}_{1} , and {a}_{3} = - \frac{2}{{t}_{f}^{3}} ( {x}_{1} - {x}_{0} ) + \frac{1}{{t}_{f}} ( {v}_{0} + {v}_{1} )$$

based on t₀, x₀, t_{f}, x₁, v₀, and v₁.

104: controlling the feet of the robot to move based on the motion trajectory.

As can be seen from the above, it obtains geometric parameter(s) of a target step first, where the geometric parameters include a step width and a step height of the target step; then determines at least two time-displacement coordinates and a velocity vector corresponding to each time-displacement coordinate based on the geometric parameters; and eventually generates a motion trajectory by fitting the at least two time-displacement coordinates and the corresponding velocity vectors so that the robot moves based on the motion trajectory. The above-mentioned method can generate the motion trajectory of the robot, so that the robot can prevent its feet from colliding violently with the step during going up and down the step, so as to improve the safety and stability.

It should be understood that, the sequence of the serial number of the steps in the above-mentioned embodiments does not mean the execution order while the execution order of each process should be determined by its function and internal logic, which should not be taken as any limitation to the implementation process of the embodiments.

FIG. 4 is a schematic block diagram of a robot motion control apparatus according to an embodiment of the present disclosure. A robot motion control apparatus for a robot is provided, where the robot is a biped robot which has two feet. For convenience of explanation, only parts related to this embodiment are shown.

The robot motion control apparatus 400 includes:

an obtaining unit 401 configured to obtain one or more geometric parameters of a target step, where the geometric parameters include a step width and a step height of the target step;

a coordinate determining unit 402 configured to determine at least two time-displacement coordinates and a velocity vector corresponding to each time-displacement coordinate based on the geometric parameters;

a trajectory generating unit 403 configured to generate a motion trajectory by fitting the at least two time-displacement coordinates and the corresponding velocity vectors; and

a control unit 404 configured to control feet of the robot to move based on the motion trajectory.

In one embodiment, the coordinate determining unit 402 includes:

a first coordinate system creating subunit configured to create a first rectangular coordinate system by taking time as a horizontal axis and a displacement in a forward direction of the robot as a vertical axis;

a forward key point determining subunit configured to determine five forward key points on the first rectangular coordinate system and forward velocity vectors each corresponding to the five forward key points, respectively, based on preset forward constraint conditions, where the coordinate of the five forward key points are respectively P₁ (0, x₀), P₂ (t1, x₁), P₃ (t₂, x₂), P₄ (t₅, x₅), and P₅ (T, x_{T}), the forward velocity vectors corresponding to the five forward key points P₁, P₂, P₃, P₄ and P₅ are vₓ₀, vₓ₁, vₓ₂, vₓ₅, and v_{xT}, respectively, and the forward constraint conditions are x₀=x₁=x₂=0, and x₅=x_{T}=xₘ, where xₘ is the maximum forward displacement determined based on the step width, vₓ₀=vₓ₁=vₓ₅=v_{xT}=0, and vₓ₂ is larger than 0;

a second coordinate system creating subunit configured to create a second rectangular coordinate system by taking time as a horizontal axis and the displacement of the robot in a vertical direction as a vertical axis; and

a vertical key point determining subunit configured to determine five vertical key points on the second rectangular coordinate system and vertical velocity vectors each corresponding to the five vertical key points respectively based on preset vertical constraint conditions, where the coordinate of the five vertical key points are respectively Q₁ (0, z₀), Q2 (t₂, z₂), Q₃ (t₃, z₃), Q₄ (t₄, z₄), and Q₅ (T, z_{T}), and the vertical velocity vectors corresponding to the five vertical key points Q₁, Q₂, Q₃, Q₄, and Q₅ are v_{z0}, vₓ₂, v_{z3}, v_{z4}, and v_{zT}, respectively, the vertical constraint conditions are z₀=0, z₃=z₄>z₂>z_{T}=h, h is the step height, v_{z0}=v_{z3}=v_{z4}=v_{zT}=0, v_{z2}>0, and T>t₅>t₄>t₃>t₂>t₁>0.

In one embodiment, the trajectory generating unit 403 includes:

an interpolation subunit configured to generate the motion trajectory by fitting the at least two time-displacement coordinates and the corresponding velocity vectors through an interpolation algorithm.

In one embodiment, the interpolation subunit includes:

a coefficient calculating subunit configured to use the at least two time-displacement coordinates and the corresponding velocity vectors as the constraint condition to calculate a coefficient of a cubic curve formula; and

a coefficient trajectory generating subunit configured to generate the motion trajectory based on the coefficient.

In one embodiment, the obtaining unit 401 includes:

a real-time detection sub-unit configured to detect in real time whether there is a step in a forward direction of the robot; and

a parameter measuring subunit configured to use the step as the target step if them is the step in the forward direction of the robot, and measure the geometric parameters of the target step.

In one embodiment, the real-time detection sub-unit includes:

a feature obtaining subunit configured to obtain a shape feature of an object in the forward direction of the robot;

a feature comparing subunit configured to compare the shape feature with a preset step shape diagram; determine there being a step in front of the robot, if the shape feature matches the step shape diagram; and determine there being no step in front of the robot, if the shape feature not matches the step shape diagram.

In this embodiment, each of the above-mentioned modules/units is implemented in the form of software, which can be computer program(s) stored in a memory of the robot motion control apparatus and executable on a processor of the robot motion control apparatus. In other embodiments, each of the above-mentioned modules/units may be implemented in the form of hardware (e.g., a circuit of the robot motion control apparatus which is coupled to the processor of the robot motion control apparatus) or a combination of hardware and software (e.g., a circuit with a single chip microcomputer).

As can be seen from the above, it obtains geometric parameter(s) of a target step first, where the geometric parameters include a step width and a step height of the target step; then determines at least two time-displacement coordinates and a velocity vector corresponding to each time-displacement coordinate based on the geometric parameters; and eventually generates a motion trajectory by fitting the at least two time-displacement coordinates and the corresponding velocity vectors so that the robot moves based on the motion trajectory. The above-mentioned method can generate the motion trajectory of the robot, so that the robot can prevent its feet from colliding violently with the step during going up and down the step, so as to improve the safety and stability.

FIG. 5 is a schematic block diagram of a robot according to an embodiment of the present disclosure. In this embodiment, a robot is provided, where the robot is a biped robot which has two feet. As shown in FIG. 5, in this embodiment, a robot 5 includes: at least one processor 50 (only one is shown in FIG. 5), a storage 51, a computer program 52 stored in the storage 51 and can be executed on the at least one processor 50, and a visual sensor 53. The processor 50 implements the following steps when the computer program 52 is executed:

obtaining, through the visual sensor 53, one or more geometric parameters of a target step, where the geometric parameters include a step width and a step height of the target step;

determining at least two time-displacement coordinates and a velocity vector corresponding to each time-displacement coordinate based on the geometric parameters;

generating a motion trajectory by fitting the at least two time-displacement coordinates and the corresponding velocity vectors; and

controlling feet of the robot to move based on the motion trajectory.

Assume that the above is the first possible implementation manner, in the second possible implementation manner provided on the basis of the first possible implementation manner, the motion trajectory includes a foot lifting trajectory segment, a back swing trajectory segment, an advancing trajectory segment, and a foot falling trajectory segment; a starting point of the back swing trajectory segment is a turning-out point of the foot lifting trajectory segment, an end point of the back swing trajectory segment and a turning-in point of the advancing trajectory segment are connected by a smooth curve, and a turning-out point of the advancing trajectory segment and a turning-in point of the foot falling trajectory segment are connected by another smooth curve;

where, the foot lifting trajectory segment is perpendicular to the advancing trajectory segment, the foot lifting trajectory segment is parallel to the foot falling trajectory segment, the end point is located on a same straight line as the foot lifting trajectory segment, and an included angle between a tangent direction of the end point and a forward direction of the robot is an acute angle.

In the third possible implementation manner provided on the basis of the first possible implementation manner, the step of determining the at least two time-displacement coordinates and the velocity vector corresponding to each time-displacement coordinate based on the geometric parameters includes:

creating a first rectangular coordinate system by taking time as a horizontal axis and a displacement in a forward direction of the robot as a vertical axis;

determining five forward key points on the first rectangular coordinate system and forward velocity vectors each corresponding to the five forward key points, respectively, based on preset forward constraint conditions, where the coordinate of the five forward key points are respectively P₁ (0, x₀), P₂ (t1, x₁), P₃ (t₂, x₂), P₄ (t₅, x₅), and P₅ (T, x_{T}), the forward velocity vectors corresponding to the five forward key points P₁, P₂, P₃, P₄ and P₅ are vₓ₀, vₓ₁, vₓ₂, vₓ₅, and v_{xT}, respectively, and the forward constraint conditions are x₀=x₁=x₂=0, and x₅=x_{T}=xₘ, where xₘ is the maximum forward displacement determined based on the step width, vₓ₀=vₓ₁=vₓ₅=v_{xT}=0, and vₓ₂ is larger than 0;

creating a second rectangular coordinate system by taking time as a horizontal axis and the displacement of the robot in a vertical direction as a vertical axis; and

determining five vertical key points on the second rectangular coordinate system and vertical velocity vectors each corresponding to the five vertical key points respectively based on preset vertical constraint conditions, where the coordinate of the five vertical key points are respectively Q₁ (0, z₀), Q₂ (t₂, z₂), Q₃ (t₃, z₃), Q₄ (t₄, z₄), and Q₅(T, z_{T}), and the vertical velocity vectors corresponding to the five vertical key points Q₁, Q₂, Q₃, Q₄, and Q₅ are v_{z0}, v_{z2}, v_{z3}, v_{z4}, and v_{zT}, respectively, the vertical constraint conditions are z₀=0, z₃=z₄>z₂>z_{T}=h. h is the step height, v_{z0}=v_{z3}=v_{z4}=v_{zT}=0, v_{z2}>0, and T>t₅>t₄>t₃>t₂>t₁>0.

In the fourth possible implementation manner provided on the basis of the first possible implementation manner, the step of generating the motion trajectory by fitting the at least two time-displacement coordinates and the corresponding velocity vectors includes:

generating the motion trajectory by fitting the at least two time-displacement coordinates and the corresponding velocity vectors through an interpolation algorithm.

In the fifth possible implementation manner provided on the basis of the fourth possible implementation manner, the step of fitting the at least two time-displacement coordinates and the corresponding velocity vectors through the interpolation algorithm to generate the motion trajectory includes:

using the at least two time-displacement coordinates and the corresponding velocity vectors as the constraint condition to calculate a coefficient of a cubic curve formula; and

generating the motion trajectory based on the coefficient.

In the sixth possible implementation manner provided on the basis of the first, the second, the third, the fourth, or the fifth possible implementation manner, the step of obtaining the geometric parameters of the target step includes:

detecting in real time whether there is a step in a forward direction of the robot; and

using the step as the target step if there is the step in the forward direction of the robot, and measuring the geometric parameters of the target step.

In the seventh possible implementation manner provided on the basis of the sixth possible implementation manner, the step of detecting in real time whether there is the step in the forward direction of the robot includes:

obtaining a shape feature of an object in the forward direction of the robot;

comparing the shape feature with a preset step shape diagram;

determining there being a step in front of the robot, if the shape feature matches the step shape diagram; an

determining there being no step in front of the robot, if the shape feature not matches the step shape diagram.

The robot 5 can include, but is not limited to, the processor 50 and the storage 51. It can be understood by those skilled in the art that FIG. 5 is merely an example of the robot 5 and does not constitute a limitation on the robot 5, and may include more or fewer components than those shown in the figure, or a combination of some components or different components. For example, the robot 5 may further include an input/output device, a network access device, and the like.

The processor 50 may be a central processing unit (CPU), or be other general purpose processor, a digital signal processor (DSP), an application specific integrated circuit (ASIC), a field-programmable gate array (FPGA), or be other programmable logic device, a discrete gate, a transistor logic device, and a discrete hardware component. The general purpose processor may be a microprocessor, or the processor may also be any conventional processor.

In some embodiments, the storage 51 may be an internal storage unit of the robot 5, for example, a hard disk or a memory of the robot 5. In other embodiments, the storage 51 may also be an external storage device of the robot 5, for example, a plug-in hard disk, a smart media card (SMC), a secure digital (SD) card, flash card, and the like, which is equipped on the robot 5. Furthermore, the storage 51 may further include both an internal storage unit and an external storage device, of the robot 5. The storage 51 is configured to store an operating system, an application program, a boot loader, data, and other program such as the above-mentioned computer program. The storage 51 can also be used to temporarily store data that has been or will be output.

As can be seen from the above, it obtains geometric parameter(s) of a target step first, where the geometric parameters include a step width and a step height of the target step; then determines at least two time-displacement coordinates and a velocity vector corresponding to each time-displacement coordinate based on the geometric parameters; and eventually generates a motion trajectory by fitting the at least two time-displacement coordinates and the corresponding velocity vectors so that the robot moves based on the motion trajectory. The above-mentioned method can generate the motion trajectory of the robot, so that the robot can prevent its feet from colliding violently with the step during going up and down the step, so as to improve the safety and stability.

It should be noted that, the information interaction, execution process, and others between the above-mentioned apparatus/units are based on the same concept as the method embodiment of the present disclosure, their functions and technical effects can be found in the method embodiment, and will not be described herein.

Those skilled in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

In the present disclosure, it further provides a computer-readable storage medium. The above-mentioned computer-readable storage medium stores a computer program, and the steps in each of the foregoing method embodiment can be implemented when the computer program is executed by a processor.

In the present disclosure, it further provides a computer program product. A robot can implement the steps in each of the foregoing method embodiment when the computer program product is executed by the robot.

When the integrated unit is implemented in the form of a software functional unit and is sold or used as an independent product, the integrated unit may be stored in a non-transitory computer-readable storage medium. Based on this understanding, all or part of the processes in the method for implementing the above-mentioned embodiments of the present disclosure are implemented, and may be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a computer memory, a read-only memory (ROM), a random access memory (RAM), electric carrier signals, telecommunication signals and software distribution media, for example, a USB flash drive, a portable hard disk, a magnetic disk, an optical disk. In some jurisdictions, in some jurisdictions, according to the legislation and patent practice, a computer readable medium does not include electric carrier signals and telecommunication signals.

In the above-mentioned embodiments, the description of each embodiment has its focuses, and the parts which are not described or mentioned in one embodiment may refer to the related descriptions in other embodiments.

Those ordinary skilled in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (or device)/robot and method may be implemented in other manners. For example, the above-mentioned apparatus/robot embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate components may or may not be physically separated. The components represented as units may or may not be physical units, that is, may be located in one place or be distributed to multiple network units. Some or all of the units may be selected according to actual needs to achieve the objectives of this embodiment.

The above-mentioned embodiments are merely intended for describing but not for limiting the technical schemes of the present disclosure. Although the present disclosure is described in detail with reference to the above-mentioned embodiments, it should be understood by those skilled in the art that, the technical schemes in each of the above-mentioned embodiments may still be modified, or some of the technical features may be equivalently replaced, while these modifications or replacements do not make the essence of the corresponding technical schemes depart from the spirit and scope of the technical schemes of each of the embodiments of the present disclosure, and should be included within the scope of the present disclosure.

What is claimed is:

1. A computer-implemented motion control method for a robot having feet, comprising executing on a processor steps of:
obtaining one or more geometric parameters of a target step, wherein the geometric parameters comprise a step width and a step height of the target step;
determining at least two time-displacement coordinates and a velocity vector corresponding to each time-displacement coordinate based on the geometric parameters;
generating a motion trajectory by fitting the at least two time-displacement coordinates and the corresponding velocity vectors; and
controlling the feet of the robot to move based on the motion trajectory.

2. The method of claim 1, wherein the motion trajectory comprises a foot lifting trajectory segment, a back swing trajectory segment, an advancing trajectory segment, and a foot falling trajectory segment; a starting point of the back swing trajectory segment is a turning-out point of the foot lifting trajectory segment, an end point of the back swing trajectory segment and a turning-in point of the advancing trajectory segment are connected by a smooth curve, and a turning-out point of the advancing trajectory segment and a turning-in point of the foot falling trajectory segment are connected by another smooth curve;
wherein, the foot lifting trajectory segment is perpendicular to the advancing trajectory segment, the foot lifting trajectory segment is parallel to the foot falling trajectory segment, the end point is located on a same straight line as the foot lifting trajectory segment, and an included angle between a tangent direction of the end point and a forward direction of the robot is an acute angle.

3. The method of claim 1, wherein the step of determining the at least two time-displacement coordinates and the velocity vector corresponding to each time-displacement coordinate based on the geometric parameters comprises:
creating a first rectangular coordinate system by taking time as a horizontal axis and a displacement in a forward direction of the robot as a vertical axis;
determining five forward key points on the first rectangular coordinate system and forward velocity vectors each corresponding to the five forward key points, respectively, based on preset forward constraint conditions, wherein the coordinate of the five forward key points are respectively P₁ (0, x₀), P₂ (t1, x₁), P₃ (t₂, x₂), P₄ (t₅, x₅), and P₅ (T, X_{T}), the forward velocity vectors corresponding to the five forward key points P₁, P₂, P₃, P₄ and P₅ are vₓ₀, vₓ₁, vₓ₂, vₓ₅, and v_{xT}, respectively, and the forward constraint conditions are x₀=x₁=x₂=0, and x₅=x_{T}=xₘ, where xₘ is the maximum forward displacement determined based on the step width, vₓ₀=vₓ₁=vₓ₅=v_{xT}=0, and vₓ₂ is larger than 0;
creating a second rectangular coordinate system by taking time as a horizontal axis and the displacement of the robot in a vertical direction as a vertical axis; and
determining five vertical key points on the second rectangular coordinate system and vertical velocity vectors each corresponding to the five vertical key points respectively based on preset vertical constraint conditions, wherein the coordinate of the five vertical key points are respectively Q₁ (0, z₀), Q₂ (t₂, z₂), Q₃ (t₃, z₃), Q₄ (t₄, z₄), and Q₅ (T, z_{T}), and the vertical velocity vectors corresponding to the five vertical key points Q₁, Q₂, Q₃, Q₄, and Q₅ are v_{z0}, v_{z2}, v_{z3}, v_{z4}, and v_{zT}, respectively, the vertical constraint conditions are z₀=0, z₃=z₄>z₂>z_{T}=h, h is the step height, v_{z0}=v_{z3}=v_{z4}=v_{zT}=0, v_{z2}>0, and T>t₅>t₄>t₃>t₂>t₁>0.

4. The method of claim 1, wherein the step of generating the motion trajectory by fitting the at least two time-displacement coordinates and the corresponding velocity vectors comprises:
generating the motion trajectory by fitting the at least two time-displacement coordinates and the corresponding velocity vectors through an interpolation algorithm.

5. The method of claim 4, wherein the step of fitting the at least two time-displacement coordinates and the corresponding velocity vectors through the interpolation algorithm to generate the motion trajectory comprises:
using the at least two time-displacement coordinates and the corresponding velocity vectors as the constraint condition to calculate a coefficient of a cubic curve formula; and
generating the motion trajectory based on the coefficient.

6. The method of claim 1, wherein the step of obtaining the geometric parameters of the target step comprises:
detecting in real time whether there is a step in a forward direction of the robot; and
using the step as the target step in response to there being the step in the forward direction of the robot, and measuring the geometric parameters of the target step.

7. The method of claim 6, wherein the step of detecting in real time whether there is the step in the forward direction of the robot comprises:
obtaining a shape feature of an object in the forward direction of the robot;
comparing the shape feature with a preset step shape diagram;
determining there being a step in front of the robot, in response to the shape feature matching the step shape diagram; and
determining there being no step in front of the robot, in response to the shape feature not matching the step shape diagram.

8. A motion control apparatus for a robot having feet, comprising:
an obtaining unit configured to obtain one or more geometric parameters of a target step, wherein the geometric parameters comprise a step width and a step height of the target step;
a coordinate determining unit configured to determine at least two time-displacement coordinates and a velocity vector corresponding to each time-displacement coordinate based on the geometric parameters;
a trajectory generating unit configured to generate a motion trajectory by fitting the at least two time-displacement coordinates and the corresponding velocity vectors; and
a control unit configured to control the feet of the robot to move based on the motion trajectory.

9. A robot having feet, comprising:
a visual sensor,
a memory;
a processor; and
one or more computer programs stored in the memory and executable on the processor, wherein the one or more computer programs comprise:
instructions for obtaining, through the visual sensor, one or more geometric parameters of a target step, wherein the geometric parameters comprise a step width and a step height of the target step;
instructions for determining at least two time-displacement coordinates and a velocity vector corresponding to each time-displacement coordinate based on the geometric parameters;
instructions for generating a motion trajectory by fitting the at least two time-displacement coordinates and the corresponding velocity vectors; and
instructions for controlling the feet of the robot to move based on the motion trajectory.

10. The robot of claim 9, wherein the motion trajectory comprises a foot lifting trajectory segment, a back swing trajectory segment, an advancing trajectory segment, and a foot falling trajectory segment; a starting point of the back swing trajectory segment is a turning-out point of the foot lifting trajectory segment, an end point of the back swing trajectory segment and a turning-in point of the advancing trajectory segment are connected by a smooth curve, and a turning-out point of the advancing trajectory segment and a turning-in point of the foot falling trajectory segment are connected by another smooth curve;
wherein, the foot lifting trajectory segment is perpendicular to the advancing trajectory segment, the foot lifting trajectory segment is parallel to the foot falling trajectory segment, the end point is located on a same straight line as the foot lifting trajectory segment, and an included angle between a tangent direction of the end point and a forward direction of the robot is an acute angle.

11. The robot of claim 9, wherein the instructions for determining the at least two time-displacement coordinates and the velocity vector corresponding to each time-displacement coordinate based on the geometric parameters comprise:
instructions for creating a first rectangular coordinate system by taking time as a horizontal axis and a displacement in a forward direction of the robot as a vertical axis;
instructions for determining five forward key points on the first rectangular coordinate system and forward velocity vectors each corresponding to the five forward key points, respectively, based on preset forward constraint conditions, wherein the coordinate of the five forward key points are respectively P₁ (0, x₀), P₂ (t1, x₁), P₃ (t₂, x₂), P₄ (t₅, x₅), and P₅ (T, x_{T}), the forward velocity vectors corresponding to the five forward key points P₁, P₂, P₃, P₄ and P₅ are vₓ₀, Vₓ₁, vₓ₂, vₓ₅, and v_{xT}, respectively, and the forward constraint conditions are x₀=x₁=x₂=0, and x₅=x_{T}=xₘ, where xₘ is the maximum forward displacement determined based on the step width, vₓ₀=vₓ₁=vₓ₅=v_{xT}=0, and vₓ₂ is larger than 0;
instructions for creating a second rectangular coordinate system by taking time as a horizontal axis and the displacement of the robot in a vertical direction as a vertical axis; and
instructions for determining five vertical key points on the second rectangular coordinate system and vertical velocity vectors each corresponding to the five vertical key points respectively based on preset vertical constraint conditions, wherein the coordinate of the five vertical key points are respectively Q₁ (0, z₀), Q₂ (t₂, z₂), Q₃ (t₃, z₃) Q₄ (t₄, z₄), and Q₅ (T, z_{T}), and the vertical velocity vectors corresponding to the five vertical key points Q₁, Q₂, Q₃, Q₄, and Q₅ are v_{z0}, v_{z2}, v_{z3}, v_{z4}, and v_{zT}, respectively, the vertical constraint conditions are z₀=0, z₃=z₄>z₂>z_{T}=h, h is the step height, v_{z0}=v_{z3}=v_{z4}=v_{zT}=0, v_{z2}>0, and T>t₅>t₄>t₃>t₂>t₁>0.

12. The robot of claim 9, wherein the instructions for generating the motion trajectory by fitting the at least two time-displacement coordinates and the corresponding velocity vectors comprise:
instructions for generating the motion trajectory by fitting the at least two time-displacement coordinates and the corresponding velocity vectors through an interpolation algorithm.

13. The robot of claim 12, wherein the instructions for fitting the at least two time-displacement coordinates and the corresponding velocity vectors through the interpolation algorithm to generate the motion trajectory comprise:
instructions for using the at least two time-displacement coordinates and the corresponding velocity vectors as the constraint condition to calculate a coefficient of a cubic curve formula; and
instructions for generating the motion trajectory based on the coefficient.

14. The robot of claim 9, wherein the instructions for obtaining the geometric parameters of the target step comprise:
instructions for detecting in real time whether there is a step in a forward direction of the robot; and
instructions for using the step as the target step in response to there being the step in the forward direction of the robot, and measuring the geometric parameters of the target step.

15. The robot of claim 14, wherein the instructions for detecting in real time whether there is the step in the forward direction of the robot comprise:
instructions for obtaining a shape feature of an object in the forward direction of the robot;
instructions for comparing the shape feature with a preset step shape diagram;
instructions for determining there being a step in front of the robot, in response to the shape feature matching the step shape diagram; and
instructions for determining there being no step in front of the robot, in response to the shape feature not matching the step shape diagram.
